(19) United States
(12) Patent Application Publication
(10) Pub. No.: US 2024/0166086 A1
(43) Pub. Date: May 23, 2024

(54) METHOD AND SYSTEM FOR CONTROLLING BATTERY OF VEHICLE, AND VEHICLE THEREOF

(71) Applicants: HYUNDAI MOTOR COMPANY, Seoul (KR); KIA CORPORATION, Seoul (KR)

(72) Inventor: Min Su Kim, II, Hwaseong-si (KR)

(73) Assignees: HYUNDAI MOTOR COMPANY, Seoul (KR); KIA CORPORATION, Seoul (KR)

(21) Appl. No.: 18/514,000

(22) Filed: Nov. 20, 2023

(30) Foreign Application Priority Data
Nov. 21, 2022 (KR) 10-2022-0156197

(51) Int. Cl. B60L 58/20; B60L 3/00; B60L 58/12

(52) U.S. Cl. CPC B60L 58/20; B60L 3/0038; B60L 58/12; B60L 2210/10; B60L 2260/54

(57) ABSTRACT

In at least one embodiment of the present disclosure, the system comprises a main battery fixedly mounted in the vehicle and configured to be a high voltage battery and supply power to a drive motor driving wheels of the vehicle, the main battery comprising a battery sensor configured to sense current or voltage of the main battery, a lower voltage battery mounted in the vehicle and configured to be a battery of a lower voltage than that of the main battery, a first DC-DC converter electrically connected between the main battery and the lower voltage battery to supply charge power from the main battery to the lower voltage battery and configured to supply power converted from the main battery to at least an electrical device in the vehicle, a second DC-DC converter electrically connected to the main battery to supply charge power thereto, a connector electrically connected to the second DC-DC converter and configured to allow the auxiliary battery to be detachably connected thereto such that the auxiliary battery is capable to supply charge power to the main battery, and a control unit configured to, when a failure of the battery sensor is identified, control the second DC-DC converter to supply the charge power from the auxiliary battery to the main battery based on estimated consumption power of the main battery.

### CROSS-REFERENCE TO RELATED APPLICATION

The present application claims priority to Korean Patent Application No. 10-2022-0156197, filed on Nov. 21, 2022, the entire contents of which is incorporated herein by reference in its entirety.

### TECHNICAL FIELD

The present disclosure relates to a method and a system of a vehicle, and the vehicle.

### BACKGROUND

The biggest drawback of a conventional electric vehicle (EV) system is a long charging time. Although a swappable battery system has been developed as an alternative to solve the long charging time, a control strategy and detailed functions for efficiently operating the swappable battery system are not sufficient to date.

According to the related art, when a voltage sensor and/or a current sensor of a main battery of a vehicle is broken down, a state of the main battery cannot be identified, and thus, in order to prevent over-discharge and over-charge of the main battery, the vehicle should be immediately stopped, which causes a limited situation in controlling a replaceable battery.

### BRIEF SUMMARY

Various aspects of the present disclosure are directed to providing a method, a system and a vehicle for controlling power supply in the vehicle such that the vehicle can safely travel in a situation where a sensor of a main battery of the vehicle is broken by controlling a use of an auxiliary battery (also referred to a replaceable battery).

Also, the aspects of the present disclosure are directed to providing a method, a system and a vehicle for controlling power supply in the vehicle such that a state of charge (SOC) of a main battery of the vehicle is maintained in the state when the main battery is broken as possibly long as it can by using an auxiliary battery.

An aspect of the present disclosure is directed to providing a method, a system, and a vehicle for controlling power supply in the vehicle by a new control technology or strategy for a battery replacement system.

A power system for a vehicle, according to an embodiment of the present disclosure, is configured to allow an auxiliary battery to be detachably connected thereto.

In at least one embodiment of the present disclosure, the system comprises a main battery fixedly mounted in the vehicle and configured to be a high voltage battery and supply power to a drive motor driving wheels of the vehicle, the main battery comprising a battery sensor configured to sense current or voltage of the main battery, a lower voltage battery mounted in the vehicle and configured to be a battery of a lower voltage than that of the main battery, a first DC-DC converter electrically connected between the main battery and the lower voltage battery to supply charge power from the main battery to the lower voltage battery and configured to supply power converted from the main battery to at least an electrical device in the vehicle, a second DC-DC converter electrically connected to the main battery to supply charge power thereto, a connector electrically connected to the second DC-DC converter and configured to allow the auxiliary battery to be detachably connected thereto such that the auxiliary battery is capable to supply charge power to the main battery, and a control unit configured to, when a failure of the battery sensor is identified, control the second DC-DC converter to supply the charge power from the auxiliary battery to the main battery based on estimated consumption power of the main battery.

In at least one embodiment of the present disclosure, the estimated consumption power is determined based on power consumption of the drive motor and a current and a voltage of the first DC-DC converter.

In at least one embodiment of the present disclosure, the estimated consumption power is determined based on efficiencies of the drive motor, the main battery and the first DC-DC converter.

In at least one embodiment of the present disclosure, the control unit is further configured to determine a charge compensation amount based on an excessive amount of the estimated consumption power over a charge limit power of the auxiliary battery or the second DC-DC converter and control the second DC-DC converter to charge the main battery additionally by the charge compensation amount after the estimated consumption power is lowered under the charge limit power.

In at least one embodiment of the present disclosure, the control unit is further configured to determine, as the charge compensation amount, an integration value obtained by integrating the excessive amount by time until the estimated consumption power is lowered under the charge limit power.

In at least one embodiment of the present disclosure, the control unit is further configured to determine a quotient value obtained by dividing the charge compensation amount by a total time duration during which the estimated consumption power exceeds the charge limit power or a predetermined charge power as a compensation charge power, and control the second DC-DC converter to charge the main battery based on the compensation charge power.

In at least one embodiment of the present disclosure, the control unit is configured to determine the quotient value as the compensation charge power when the charge compensation amount is greater than a predetermined value, and determine the predetermined charge power as the compensation charge power when the charge compensation amount is equal to or less than the predetermined value.

In at least one embodiment of the present disclosure, the control unit is further configured to determine a minimum value of the estimated consumption power and the charge limit power as the charge power of the auxiliary battery to charge the main battery.

In at least one embodiment of the present disclosure, the control unit is further configured to control the second DC-DC converter to charge the main battery by the estimated consumption power when the estimated consumption power is smaller than the charge limit power.

In at least one embodiment of the present disclosure, the control unit is configured to update the charge compensation amount by an amount of the main battery being charged by the compensation charge power.

According to an embodiment of the present disclosure, a method for controlling a power system of a vehicle, which is configured to allow an auxiliary battery to be detachably connected thereto and comprises a main battery fixedly mounted in the vehicle and configured to be a high voltage battery and supply power to a drive motor driving wheels of the vehicle, the main battery comprising a battery sensor configured to sense current or voltage of the main battery, a lower voltage battery mounted in the vehicle and configured to be a battery of a lower voltage than that of the main battery, a first DC-DC converter electrically connected between the main battery and the lower voltage battery to supply charge power from the main battery to the lower voltage battery and configured to supply power converted from the main battery to at least an electrical device in the vehicle, a second DC-DC converter electrically connected to the main battery to supply charge power thereto, a connector electrically connected to the second DC-DC converter and configured to allow the auxiliary battery to be detachably connected thereto such that the auxiliary battery is capable to supply charge power to the main battery, and a control unit, comprises determining, by the control unit, estimated consumption power of the main battery in response to a failure of the battery sensor, and controlling, by the control unit, the second DC-DC converter to supply the charge power from the auxiliary battery to the main battery based on the estimated consumption power.

In at least one embodiment of the method, the estimated consumption power is determined based on power consumption of the drive motor and a current and a voltage of the first DC-DC converter.

In at least one embodiment of the method, the method further comprises determining a charge compensation amount based on an excessive amount of the estimated consumption power over a charge limit power of the auxiliary battery or the second DC-DC converter and controlling the second DC-DC converter to charge the main battery additionally by the charge compensation amount after the estimated consumption power is lowered under the charge limit power.

In at least one embodiment of the method, the method further comprises determining, as the charge compensation amount, an integration value obtained by integrating the excessive amount by time until the estimated consumption power is lowered under the charge limit power.

In at least one embodiment of the method, the method further comprises determining a quotient value obtained by dividing the charge compensation amount by a total time duration during which the estimated consumption power exceeds the charge limit power or a predetermined charge power as a compensation charge power, and controlling the second DC-DC converter to charge the main battery based on the compensation charge power.

In at least one embodiment of the method, the method further comprises determining the quotient value as the compensation charge power when the charge compensation amount is greater than a predetermined value, and determining the predetermined charge power as the compensation charge power when the charge compensation amount is equal to or less than the predetermined value.

In at least one embodiment of the method, the method further comprises determine a minimum value of the estimated consumption power and the charge limit power as the charge power of the auxiliary battery to charge the main battery.

In at least one embodiment of the method, the method further comprises controlling the second DC-DC converter to charge the main battery by the estimated consumption power when the estimated consumption power is smaller than the charge limit power.

In at least one embodiment of the method, the method further comprises updating the charge compensation amount by an amount of the main battery being charged by the compensation charge power.

A vehicle, according to an embodiment of the present disclosure, comprises a power system which a main battery fixedly mounted in the vehicle and configured to be a high voltage battery and supply power to a drive motor driving wheels of the vehicle, the main battery comprising a battery sensor configured to sense current or voltage of the main battery, a lower voltage battery mounted in the vehicle and configured to be a battery of a lower voltage than that of the main battery, a first DC-DC converter electrically connected between the main battery and the lower voltage battery to supply charge power from the main battery to the lower voltage battery and configured to supply power converted from the main battery to at least an electrical device in the vehicle, a second DC-DC converter electrically connected to the main battery to supply charge power thereto, and a connector electrically connected to the second DC-DC converter and configured to allow the auxiliary battery to be detachably connected thereto such that the auxiliary battery is capable to supply charge power to the main battery, and a control unit configured to, when a failure of the battery sensor is identified, control the second DC-DC converter to supply the charge power from the auxiliary battery to the main battery based on estimated consumption power of the main battery.

The method and system of a vehicle, and a vehicle according to an embodiment of the present disclosure may solve a problem that a vehicle cannot travel when a problem occurs in a battery sensor of a main battery in the related art.

For example, a method and a system of a vehicle, and the vehicle may prevent overcharging and over discharging of a main battery in a failure situation of a battery sensor of the main battery, thereby improving safety of the main battery.

In addition, for example, the method and system for controlling the battery of the vehicle and the vehicle may maintain SOC of the main battery as much as SOC of the auxiliary battery even in a failure situation of the battery sensor of the main battery, thereby making it possible to stably drive the vehicle.

### BRIEF DESCRIPTION OF DRAWINGS

FIG. 1 is a block diagram of a system of a vehicle according to an embodiment of the present disclosure.

FIG. 2 is a flowchart of a battery control operation of a system according to an embodiment of the present disclosure.

FIG. 3 is a diagram for describing a battery control operation of a system according to an embodiment of the present disclosure.

FIGS. 4a and 4b are flowcharts illustrating an operation of a battery control system according to an embodiment of the present disclosure.

### DETAILED DESCRIPTIONS

Like reference numerals refer to like elements throughout the specification. The present specification does not describe all elements of the embodiments, and general contents in the technical field to which the present disclosure pertains or overlapping contents between the embodiments are omitted. The term “unit, module, or device” used in the specification may be implemented by software or hardware, and according to embodiments, a plurality of “units, modules, or devices” may be implemented as one component, or one “unit, module, or device” may include a plurality of components.

Throughout the specification, when a part is “connected” to another part, it includes the case of being directly connected and the case of being indirectly connected, and the indirect connection includes being connected through a wireless communication network.

In addition, when a part “includes” a component, this means that other components may be further included, rather than excluding other components unless specifically stated otherwise.

The terms “first”, “second”, etc. are used to distinguish one component from another, and the components are not limited by the above terms.

A singular expression includes a plural expression unless there is a clear exception in the context.

In each step, the identification code is used for convenience of description, and the identification code does not describe the order of each step, and each step may be performed differently from the stated order unless a specific order is clearly described in the context.

In the present disclosure, a main battery and an auxiliary battery (also referred to as a replaceable battery) of a vehicle are capable of transmitting energy through a direct current converter (also referred to a second DC-DC converter). The present disclosure relates to a control strategy of a system.

In the related art, when a battery sensor (e.g., a current sensor and/or a voltage sensor) of a main battery of a vehicle is in a failure situation, a control unit of the vehicle cannot determine a state of charge (SOC) of the main battery, and thus the vehicle should be immediately stopped.

In order to solve the problems of the related art, the present disclosure may provide a control technology capable of minimizing a change in SOC of a main battery of a vehicle and coping with a failure situation of a battery sensor of the main battery by calculating a power consumption of the main battery by using RPM and torque of a motor of the vehicle, power consumption of a first DC-DC Converter (e.g. a Low Voltage DC-DC Converter (LDC)), and/or efficiency of various hardware and then charging the main battery by the calculated power consumption through an auxiliary battery.

According to an embodiment of the present disclosure, a charging power for charging a main battery through an auxiliary battery may be determined based on estimated consumption power of the main battery. Also, the charge power is determined in further consideration of a charge limit power of the second DC-DC converter, e.g. a high voltage DC-DC Converter (HDC), and/or a charge limit power of the auxiliary battery. The charge power may be determined to be the lower charge limit power between those of the second DC-DC converter and the auxiliary battery.

In addition, according to an embodiment of the present disclosure, when the determined charging power for charging the main battery exceeds the charge limit power and the auxiliary battery is available to further supply power for charging, the auxiliary battery is controlled to supply power to the main battery based on an integrated amount of power for the time duration during the charge power exceeds the limit power.

Hereinafter, embodiments of the present disclosure will be described with reference to the accompanying drawings.

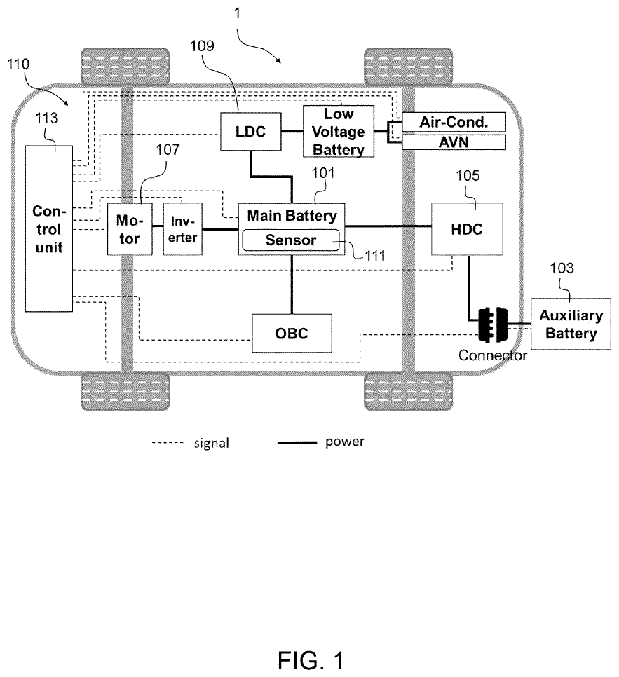

FIG. 1 is a block diagram of a power system of a vehicle according to an embodiment of the present disclosure, which is in a state where an auxiliary battery 103 is connected thereto.

Referring to FIG. 1, the system may include a main battery 101, a high voltage DC-DC converter (HDC) 105 as a second DC-DC converter, a drive motor 107, a low voltage DC-DC converter (LDC) 109 as a first DC-DC converter, and a control unit 113.

The main battery 101 may be embedded in the vehicle 1.

The main battery 101 may be a super capacitor lithium ion battery. Of course, the battery may be a high voltage battery for an electric vehicle such as a nickel metal battery, a lithium polymer battery, or an all-solid battery. In addition, the main battery 140 may be a battery pack in which battery cells are connected in series and/or in parallel.

The auxiliary battery 103 (also referred to a replaceable battery) may be detachably connected to the power system as replaceable.

The auxiliary battery 103 may be a lead acid battery, but is not limited thereto, and may be a nickel metal battery, a lithium polymer battery, or a lithium ion battery.

The auxiliary battery 103 may supply charge power to the main battery 10 by the HDC 105 being controlled by the control unit 113 charge power.

In addition, the auxiliary battery 103 may be charged by receiving charge power from the main battery 101 charge power.

The HDC 105 may control a current movement direction between the main battery 101 and the auxiliary battery 103 and allow the main battery 101 and the auxiliary battery 103 to exchange power with each other.

The drive motor 107 may receive power (e.g., high voltage power) from the main battery 101 to drive the vehicle 1, which may be an AC motor.

The LDC 109 may convert power supplied from the main battery 101 into a lower voltage and transmit to electric devices in the vehicle such as an air-conditioning device, a AVNT (Audio Video Navigation Telematics) device, etc. which consume the lower voltage power.

Also, the LDC 109 may be used to charge a low voltage battery that is provided in the vehicle 1.

The battery sensor 111 may include one or more sensors capable of obtaining state information of the main battery 101. The battery sensor 111 may be embedded in the main battery 101

For example, the battery sensor 111 may include a voltage sensor (not shown) capable of measuring the voltage of the main battery 101 and/or a current sensor (not shown) capable of measuring the current of the main battery 101.

The control unit 113 (also referred to a control circuit) may control at least one device of the main battery 101, the auxiliary battery 103, the HDC 105, the drive motor 107, the LDC 109, and/or the battery sensor 111 of the system 100, and may perform various data processes and calculations. The control unit 113 may include a processor and a memory. The control unit 113 according to an exemplary embodiment of the present disclosure may be a hardware device implemented by various electronic circuits (e.g., computer, microprocessor, CPU, ASIC, circuitry, logic circuits, etc.). The control unit 113 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The control unit 113 may determine charge power of the auxiliary battery 103 for charging the main battery 101 based on estimated consumption power of at least one of the drive motor 107 and the LDC 190 when a failure of the battery sensor 111 is identified. In addition, the control unit 113 may determine a charge compensation amount by integrating by time the exceeding power of the estimated consumption power exceeding the charge limit power of the auxiliary battery 103 or the HDC 105. The exceeding power may be determined by subtracting the limit power from the estimated consumption power. In addition, the control unit 113 may control the HDC 105 to charge the main battery 101 by the auxiliary battery 103 based on the charge compensation amount after the estimated consumption power is lower under the limit power.

For example, the control unit 113 may determine a result value (i.e. a quotient value) of dividing the charge compensation amount by a total elapsed time duration during which the estimated consumption power exceeds the charge limit power or a predetermined value as a compensation charge power. Also, the control unit 113 may control the HDC 105 based on the determined compensation charge power so that the auxiliary battery 103 charges the main battery 101. For example, the predetermined value may be 0 (zero) or a value close to 0 (zero) within a predetermined range.

When a warning light is turned on due to a situation or the like where the main battery 101 is discharged to a preset level, or the auxiliary battery is connected to the power system of the vehicle 1, or the state of charge (SOC) of the auxiliary battery 103 is greater than a predetermined level, the control unit 113 may perform an operation of determining the charge amount of the auxiliary battery 103 to the main battery 101, and control the HDC 105 to charge the main battery 101.

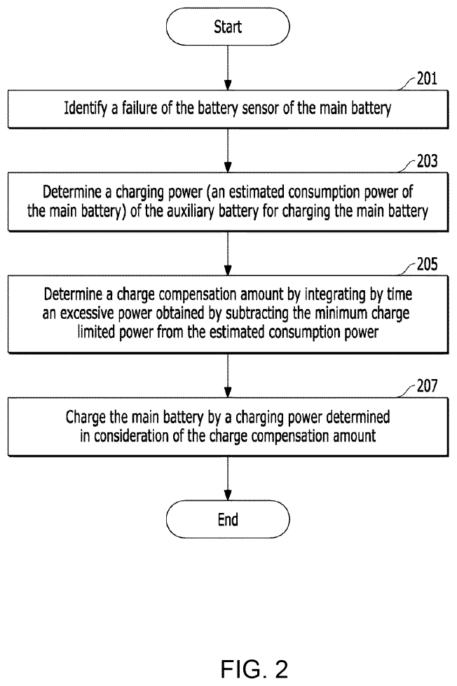

An embodiment of a detailed operation of the control unit 113 will be described later with reference to FIGS. 2 to 4B.

Meanwhile, in the embodiment of FIG. 1, the auxiliary battery 103 is illustrated as being mounted inside the vehicle 1, but according to another embodiment, the auxiliary battery 103 may be provided as mounted in a separate mobility which can be mechanically connected to the vehicle 1. Also, for example, the HDC 105 may also be provided as detachably mounted in the vehicle 1 and electrically connected to the power system.

FIG. 2 is a flowchart of a control method of the system according to an embodiment.

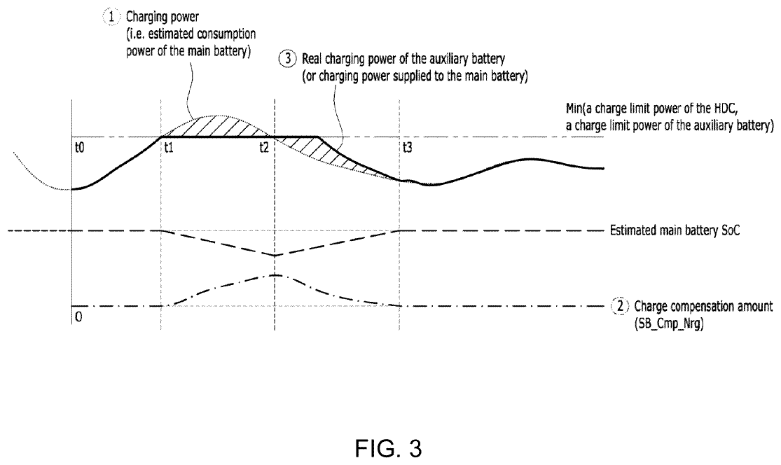

FIG. 3 is a diagram for describing the charge power of the auxiliary battery, the SoC of the main battery, and the charge compensation amount with exemplary estimated consumption power by time.

Referring to FIG. 2, the system 100 may identify a failure of the battery sensor 111 of the main battery 101 (201).

Referring to FIG. 3, a zero time point to indicates a time point at which a failure occurs in the battery sensor 111.

When the battery sensor 111 fails, the system 100 may not be able to determine a state of charge (SOC) of the main battery 101. Accordingly, if the auxiliary battery 103 is controlled to charge the main battery 101 in a state where the battery sensor 111 is out of order, the main battery 101 may be over-charged, and if the auxiliary battery 103 is not controlled to charge the main battery 101, then the main battery 101 may be over-discharged by the power consumption of the drive motor or the electrical devices of the vehicle 1.

If the SOC of the main battery 101 is maintained to be the same as the zero time point to, overcharge and/or over-discharge of the main battery 101 may be prevented, and also, the problem that the vehicle 1 is stopped because the SOC cannot be determined may be solved.

For example, in an embodiment of the present disclosure, in order for the system 100 to maintain the SOC of the main battery 101 to be the same as the zero time point, the HDC 105 and/or the auxiliary battery 103 may be controlled to charge the main battery 101 by the auxiliary battery 103 as much as the power used during the driving of the vehicle 1 in a manner to be described below.

To this end, the system 100 may determine a charge power of the auxiliary battery 103 for charging the main battery 101 in response to the failure identification of the battery sensor 111 of the main battery 101 in operation 201 (203).

For example, the system 100 may determine an estimated consumption power of the main battery 101 by Equation 1 below.

P_{e·c}=(Rpm*T)/ηₘₒₜ+(V_{LDC}*I_{LDC})/η_{Main Batt}/η_{LDC} Equation 1:

wherein Pe·c denotes the estimated consumption power, Rpm denotes a rotation speed of the drive motor 107, T denotes a torque of the drive motor 107, V_{LDC} denotes a voltage of the LDC 109, I_{LDC} denotes a current of the LDC 109, ηₘₒₜ denotes an efficiency of the drive motor 107, η_{Main Batt} denotes an efficiency of the main battery 101, and η_{HDC} denotes an efficiency of the HDC 105.

In Equation 1, the efficiency of the drive motor 107, the efficiency of the main battery 101, and the efficiency of the HDC 105 each may have a predetermined efficiency value according to predetermined conditions.

For example, the efficiency of the drive motor 107, the efficiency of the main battery 101, and the efficiency of the HDC 105 each may be predetermined for each range of the number of rotations and/or the torque of the drive motor 107.

Also, the system 100 may determine a charge compensation amount by integrating an excessive power which may be determined by subtracting a charge limit power from the estimated consumption power (205). The charge limit power may be determined to be a lower one of a charge limit powers of the auxiliary battery 103 or the charge limit power of the HDC 105.

Referring back to FIG. 3, the estimated consumption power exceeds the limit power during a time period from the first time point t1 to the second time point t2, and charge compensation amount SB_Cmp_Nrg may be determined by integrating the excessive power by time for the period t1-t2 of time.

The HDC 105 and the auxiliary battery 103 each has a predetermined charge limit power, and when the main battery 101 requires a power greater than the predetermined charge limit power of the devices, the auxiliary battery 103 cannot charge the main battery 101 by the required power, i.e. the estimated consumption power, and accordingly, the SOC of the main battery 101 is reduced.

For example, after the first time point t1, when the estimated consumption power is higher than the minimum charge limit power among the charge limit powers of the HDC 105 and the auxiliary battery 103, since the auxiliary battery 103 cannot charge the main battery 101 by the same power required by the vehicle 1, the SOC of the main battery 101 may be reduced from that of the first time point t1.

For example, as shown in FIG. 3, the system 100 may estimate that the SCO of the main battery decreases from the first time point t1 to the second time point t2.

Accordingly, in the system 100, in order to increase the SOC of the main battery 101 by as much amount as was reduced during the period t1-t2, the excessive power of the estimated consumption power may be integrated by time for the period t1-t2 to output the charge compensation amount SB_Cmp_Nrg.

For example, the system 100 may determine the charge compensation amount by Equation 2 below.

SB_Cmp_Nrg=+∫ₜ₁^{t2}{P_{e·c}−min(P_{1,HDC},P_{1,SB})}dt Equation 2:
wherein SB_Cmp_Nrg denotes a charge compensation amount, P_{1,HDC} denotes a charge limit power of the HDC 105, P_{1,SB} denotes a charge limit power of the auxiliary battery 103.

In Equation 2, the charge limit power of the HDC 105 and the charge limit power of the auxiliary battery 103 each may be predetermined for each predetermined condition.

For example, the charge limit power of the HDC 105 and the charge limit power of the auxiliary battery 103 may be predetermined for each predetermined temperature range.

The system 100 may charge the main battery 101 based on the charge compensation amount after the second time point t2 at which the estimated consumption power is lowered under the limit power (207).

Referring to FIG. 3, a time period t2-t3 from the second time point t2 to the fourth time point t3 may be referred to as a charge compensation period.

From the second time point t2, it can be seen that the estimated consumption power becomes smaller than the minimum charge limit.

Accordingly, since additional charge power over the estimated consumption power is available with the auxiliary batter 103 from the second time point t2, the system 100 may start charging the main battery 101 through the previously determined charge compensation amount SB_Cmp_Nrg from the second time point t2.

The compensation charge power for charging the main battery 10 may be determined through Equation 3 below.

Cmp_Pwr=SB_Cmp_Nrg/(t2−t1) Equation 3:
wherein Cmp_Pwr denotes a compensation charge power.

The compensation charge power may be determined such that the main battery 101 is quickly charged at an initial stage of the time interval t2-t3 and slowly charged to be converged to the SOC of the main battery 101 at the first time t1, thereby removing the risk of being over-discharged.

For example, the system 100 may control the HDC 105 and/or the auxiliary battery 103 to charge the main battery 101 based on the total charge power obtained by adding the compensation charge power Cmp_Pwr to the estimated consumption power at the second time t2. In this case, the system 100 needs to further consider the charge limit power.

In other words, the system 100 may control the HDC 105 and/or the auxiliary battery 103 to charge the main battery 101 with the minimum power among the total charge power, the charge limit power of the HDC 105 and the charge limit power of the auxiliary battery 103.

While the main battery 101 is charged from the second time point t2, the SOC of the main battery 101 is gradually increased, and the system 100 may determine that the SOC of the main battery 101 reaches the SOC of the zero time point to at the third time point t3.

The third time point t3 is a time point when the total charge power becomes equal to the estimated consumption power as shown.

Meanwhile, while the main battery 101 is charged based on the compensation charge power Cmp_Pwr, the charge compensation amount SB_Cmp_Nrg may be subtracted by the amount charged by the compensation charge power Cmp_Pwr, thereby being updated.

For example, when the main battery 101 is additionally charged based on the compensation charge power Cmp_Pwr, the system 100 may update the charge compensation amount SB_Cmp_Nrg by Equation 4 below.

SB_Cmp_Nrg=SB_Cmp_Nrg−∫ₜ₁^{t2}(Pr−Pe·c)dt Equation 4:
wherein Pr denotes a real charging power supplied to the main battery 101 for charging.

According to Equation 4, the charge compensation amount SB_Cmp_Nrg converges to 0 (zero), and thus the charge compensation amount SB_Cmp_Nrg may be initialized.

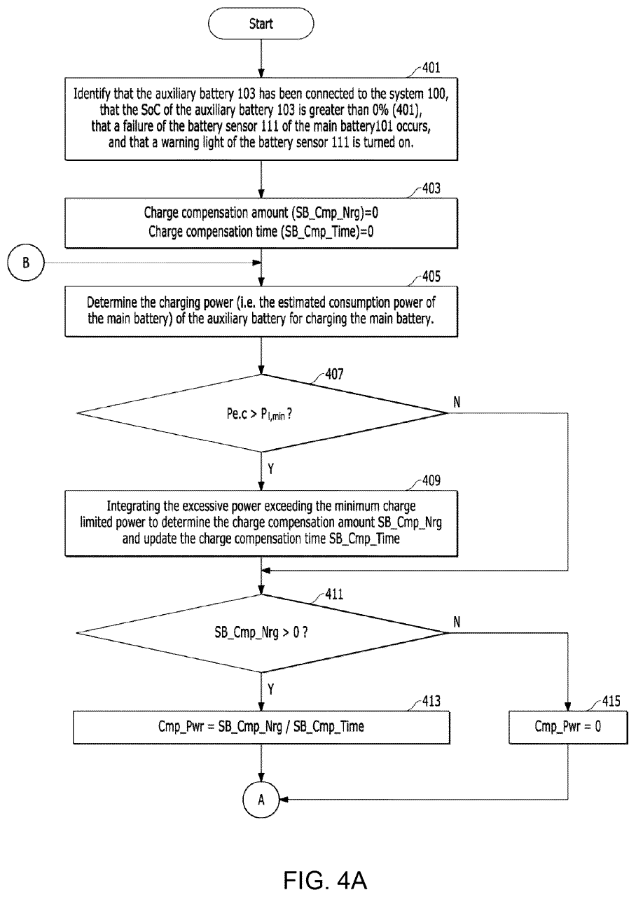

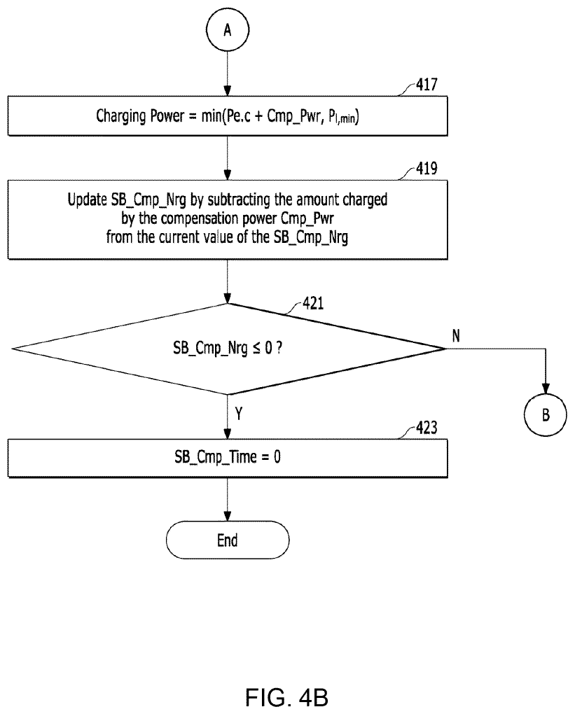

FIG. 4A and FIG. 4B are flowcharts showing operations of the system 100 (and/or the control unit 113) according to an embodiment of the present disclosure.

Referring to FIGS. 4A and 4B, the system 100 may identify that the auxiliary battery 103 has been connected to the system 100, that the SOC of the auxiliary battery 103 is greater than 0% (401), that a failure of the battery sensor 111 of the main battery 101 occurs, and that a warning light of the battery sensor 111 is turned on (401).

Based on operation 401, the system 100 may set the charge compensation amount SB_Cmp_Nrg and the charge compensation time SB_Cmp_Time to 0 (403). In FIG. 3, the charge compensation time SB_Cmp_Time corresponds to the time period t1-t2.

The system 100 may determine an estimated consumption power of the main battery 101 as a charging power SB_charge_power for charging the main battery 101 by the auxiliary battery 103 (405).

For example, based on a torque of the motor 107, a voltage value of the LDC 109, a current value of the LDC 109, the efficiency of the drive motor 107, the efficiency of the main battery 101, and the efficiency of the HDC 105, the system 100 may determine the estimated consumption power through Equation 1 described above and determine the estimated consumption power as the charging power SB_charge_power.

The system 100 may determine whether the estimated consumption power is greater than the minimum charge limit power (407).

For example, the minimum charge limit power may include a minimum charge limit power among the charge limit power of the HDC 105 and the charge limit power of the auxiliary battery 103.

The system 100 performs operation 409 when the estimated consumption power of the auxiliary battery 103 is greater than the minimum charge limit power, or otherwise, performs operation 411.

The system 100 may determine the charge compensation amount SB_Cmp_Nrg by integrating the excessive power exceeding the minimum charge limit power among the estimated consumption power during a time period in which the estimated consumption power is higher than the minimum charge limit power, and update the charge compensation time SB_Cmp_Time (409).

For example, the system 100 may update the charge compensation amount SB_Cmp_Nrg by integrating the excessive power through Equation 2 described above.

In addition, the system 100 may update the charge compensation time SB_Cmp_Time by adding the total time of the time period t2-t1 in FIG. 3 to the current value of the charge compensation time SB_Cmp_Time, as shown in Equation 5 below.

SB_Cmp_Time=SB_Cmp_Time+(t2−t1) Equation 5:

The system 100 may determine whether the charge compensation amount SB_Cmp_Nrg is greater than 0 (zero) (411) when it is determined that the estimated consumption power is equal to or less than the minimum charge limit power in operation 407 or after operation 409.

The system 100 may perform operation 413 when the charge compensation amount SB_Cmp_Nrg is greater than 0, and may perform operation 415 otherwise.

When the charge compensation amount SB_Cmp_Nrg is greater than 0, the system 100 may determine the compensation charge power Cmp_Pwr by dividing the charge compensation amount SB_Cmp_Nrg by the charge compensation time SB_Cmp_Time (or t2-t1 in Equation 3 described above) (413).

For example, when the charge compensation amount SB_Cmp_Nrg is greater than 0, the system 100 may determine the compensation charge power Cmp_Pwr by Equation 3 described above, and in this case, (t2-t1) in Equation 3 may be the charge compensation time SB_Cmp_Time.

When the charge compensation amount SB_Cmp_Nrg is equal to or less than 0, the system 100 may determine the compensation charge power Cmp_Pwr as 0 to initialize it (415).

After operation 413 or operation 415, the system 100 may determine a minimum value between the total charge power Pt obtained by adding the compensation charge power Cmp_Pwr to the estimated consumption power P_{e·c} and the minimum charge limit power P_{1,min} as the charging power for charging the main battery 101 by the auxiliary battery 103 (417).

The system 100 may control the HDC 105 and/or the auxiliary battery 103 such that the auxiliary battery 103 charges the main battery 101 with the determined charging power.

The system 100 may update the charge compensation amount SB_Cmp_Nrg by subtracting the amount as much as charged by the compensation charge power from the current value of the charge compensation amount SB_Cmp_Nrg (419).

For example, the system 100 may update the charge compensation amount SB_Cmp_Nrg by Equation 4 described above.

The system 100 may determine whether the updated value of the charge compensation amount SB_Cmp_Nrg is equal to or less than 0 (421).

The system 100 may perform operation 423 when the current value of the charge compensation amount SB_Cmp_Nrg is equal to or less than 0, and otherwise may return to the operation 405 again.

The system 100 according to the above-described embodiment determines a required charging power of the auxiliary battery 103, i.e. an estimated consumption power when the battery sensor 111 fails, determines the charge compensation amount by integrating the excessive power among the required charging power exceeding the minimum charge limit power of the charge limit powers of the auxiliary battery 103 or the HDC 105, and then allows the auxiliary battery 103 to charge the main battery 101 based on the determined charge compensation amount in addition to the charging by the required charging power after it is lowered under the minimum charge limit power.

According to another embodiment, when the battery sensor 111 fails, the system 100 may determine a predetermined value for each condition (e.g., the charge amount of the auxiliary battery 103) to be the charge compensation amount, and thus the auxiliary battery 103 may charge the main battery 101 based on the predetermined value.

In addition, according to another embodiment of the present disclosure, the feed forward may be predetermined in advance, and the auxiliary battery 103 may charge the main battery 101 while recognizing a current condition of each component of the system 100 (for example, a condition of the main battery 101, the auxiliary battery 103, and/or the HDC 105) through other components other than the drive motor 107 connected to the main battery 101.

The above-described embodiments may be implemented in the form of a recording medium for storing instructions executable by a computer. The instructions may be stored in the form of program code. In addition, when executed by the processor, a program module may be generated to perform operations of the disclosed embodiments. The recording medium may be implemented as a computer-readable recording medium.

The computer-readable recording medium includes all types of recording media in which computer-readable instructions are stored. For example, there may be a Read Only Memory (ROM), a Random Access Memory (RAM), a magnetic tape, a magnetic disk, a flash memory, an optical data storage device, etc.

Also, the term “unit” or “control unit” in the above description is merely a widely used term for naming a controller configured for controlling a specific vehicle function, and does not mean a generic functional unit. For example, the unit may include a communication device communicating with another unit or sensor, a non-transitory memory storing an OS or logic command, input/output information, etc., and one or more processors (e.g., computer, microprocessor, CPU, ASIC, circuitry, logic circuits, etc.) performing its programmed functionality through judgment, calculation, determination, and the like.

The embodiments disclosed above have been described with reference to the accompanying drawings. It will be understood by those skilled in the art that the present disclosure may be implemented in a different form from the disclosed embodiments without changing the technical spirit or essential feature of the present disclosure. The disclosed embodiments are illustrative and should not be construed as limiting.

What is claimed is:

1. A power system of a vehicle configured to allow an auxiliary battery to be detachably connected thereto, the system comprising:
a main battery fixedly mounted in the vehicle and configured to be a high voltage battery and supply power to a drive motor driving wheels of the vehicle, the main battery comprising a battery sensor configured to sense current or voltage of the main battery;
a lower voltage battery mounted in the vehicle and configured to be a battery of a lower voltage than that of the main battery;
a first DC-DC converter electrically connected between the main battery and the lower voltage battery to supply charge power from the main battery to the lower voltage battery and configured to supply power converted from the main battery to at least one electrical device in the vehicle;
a second DC-DC converter electrically connected to the main battery to supply charge power thereto;
a connector electrically connected to the second DC-DC converter and configured to allow the auxiliary battery to be detachably connected thereto such that the auxiliary battery is capable to supply charge power to the main battery; and
a control unit configured to, when a failure of the battery sensor is identified, control the second DC-DC converter to supply the charge power from the auxiliary battery to the main battery based on estimated consumption power of the main battery.

2. The system according to claim 1, wherein the estimated consumption power is determined based on power consumption of the drive motor and a current and a voltage of the first DC-DC converter.

3. The system according to claim 2, wherein the estimated consumption power is determined based on efficiencies of the drive motor, the main battery and the first DC-DC converter.

4. The system according to claim 1, wherein the control unit is further configured to determine a charge compensation amount based on an excessive amount of the estimated consumption power over a charge limit power of the auxiliary battery or the second DC-DC converter and control the second DC-DC converter to charge the main battery additionally by the charge compensation amount after the estimated consumption power is lowered under the charge limit power.

5. The system according to claim 4, wherein the control unit is further configured to determine, as the charge compensation amount, an integration value obtained by integrating the excessive amount by time until the estimated consumption power is lowered under the charge limit power.

6. The system according to claim 5, wherein the control unit is further configured to determine a quotient value obtained by dividing the charge compensation amount by a total time duration during which the estimated consumption power exceeds the charge limit power or a predetermined charge power as a compensation charge power, and control the second DC-DC converter to charge the main battery based on the compensation charge power.

7. The system according to claim 6, wherein the control unit is configured to determine the quotient value as the compensation charge power when the charge compensation amount is greater than a predetermined value, and determine the predetermined charge power as the compensation charge power when the charge compensation amount is equal to or less than the predetermined value.

8. The system according to claim 6, wherein the control unit is further configured to determine a minimum value of the estimated consumption power and the charge limit power as the charge power of the auxiliary battery to charge the main battery.

9. The system according to claim 6, wherein the control unit is further configured to control the second DC-DC converter to charge the main battery by the estimated consumption power when the estimated consumption power is smaller than the charge limit power.

10. The system according to claim 9, wherein the control unit is configured to update the charge compensation amount by an amount of the main battery being charged by the compensation charge power.

11. A method for controlling a power system of a vehicle, which is configured to allow an auxiliary battery to be detachably connected thereto and comprises a main battery fixedly mounted in the vehicle and configured to be a high voltage battery and supply power to a drive motor driving wheels of the vehicle, the main battery comprising a battery sensor configured to sense current or voltage of the main battery, a lower voltage battery mounted in the vehicle and configured to be a battery of a lower voltage than that of the main battery, a first DC-DC converter electrically connected between the main battery and the lower voltage battery to supply charge power from the main battery to the lower voltage battery and configured to supply power converted from the main battery to at least an electrical device in the vehicle, a second DC-DC converter electrically connected to the main battery to supply charge power thereto, a connector electrically connected to the second DC-DC converter and configured to allow the auxiliary battery to be detachably connected thereto such that the auxiliary battery is capable to supply charge power to the main battery, and a control unit, the method comprising:
determining, by the control unit, estimated consumption power of the main battery in response to a failure of the battery sensor; and
controlling, by the control unit, the second DC-DC converter to supply the charge power from the auxiliary battery to the main battery based on the estimated consumption power.

12. The method according to claim 11, wherein the estimated consumption power is determined based on power consumption of the drive motor and a current and a voltage of the first DC-DC converter.

13. The method according to claim 11, further comprising: determining a charge compensation amount based on an excessive amount of the estimated consumption power over a charge limit power of the auxiliary battery or the second DC-DC converter and controlling the second DC-DC converter to charge the main battery additionally by the charge compensation amount after the estimated consumption power is lowered under the charge limit power.

14. The method according to claim 13, further comprising: determining, as the charge compensation amount, an integration value obtained by integrating the excessive amount by time until the estimated consumption power is lowered under the charge limit power.

15. The method according to claim 13, further comprising: determining a quotient value obtained by dividing the charge compensation amount by a total time duration during which the estimated consumption power exceeds the charge limit power or a predetermined charge power as a compensation charge power, and controlling the second DC-DC converter to charge the main battery based on the compensation charge power.

16. The method according to claim 15, further comprising: determining the quotient value as the compensation charge power when the charge compensation amount is greater than a predetermined value, and determining the predetermined charge power as the compensation charge power when the charge compensation amount is equal to or less than the predetermined value.

17. The method according to claim 15, further comprising: determining a minimum value of the estimated consumption power and the charge limit power as the charge power of the auxiliary battery to charge the main battery.

18. The method according to claim 15, further comprising: controlling the second DC-DC converter to charge the main battery by the estimated consumption power when the estimated consumption power is smaller than the charge limit power.

19. The method of claim 18, further comprising: updating the charge compensation amount by an amount of the main battery being charged by the compensation charge power.

20. A vehicle comprising a power system configured to allow an auxiliary battery to be detachably connected thereto, wherein the power system comprises:
a main battery fixedly mounted in the vehicle and configured to be a high voltage battery and supply power to a drive motor driving wheels of the vehicle, the main battery comprising a battery sensor configured to sense current or voltage of the main battery;
a lower voltage battery mounted in the vehicle and configured to be a battery of a lower voltage than that of the main battery;
a first DC-DC converter electrically connected between the main battery and the lower voltage battery to supply charge power from the main battery to the lower voltage battery and configured to supply power converted from the main battery to at least an electrical device in the vehicle;
a second DC-DC converter electrically connected to the main battery to supply charge power thereto;
a connector electrically connected to the second DC-DC converter and configured to allow the auxiliary battery to be detachably connected thereto such that the auxiliary battery is capable to supply charge power to the main battery; and
a control unit configured to, when a failure of the battery sensor is identified, control the second DC-DC converter to supply the charge power from the auxiliary battery to the main battery based on estimated consumption power of the main battery.
